(19) United States
(12) Patent Application Publication
(10) Pub. No.: US 2007/0035406 A1
(43) Pub. Date: Feb. 15, 2007

(54) Compact smoke alarm

(76) Inventors: Quentin David Cook, Victoria (AU); Paul Edward Davies, Victoria (AU); Neale Terrens Kelly, Victoria (AU)

Correspondence Address: GREENBLUM & BERNSTEIN, P.L.C., 1950 ROLAND CLARKE PLACE, RESTON, VA, 20191, US

(21) Appl. No.: 10/568,807

(22) PCT Filed: Aug. 16, 2004
(86) PCT No.: PCT/AU04/01091

§ 371 Date: Jul. 21, 2006

(30) Foreign Application Priority Data
Aug. 20, 2003 (AU) 20039304456

(51) Int. Cl. G08B 17/10

(52) U.S. Cl. 340/630

(57) ABSTRACT

A compact smoke alarm assembly (10) is disclosed. The assembly (10) comprises: a smoke detection chamber (20) defined by a body (22) having a plurality of openings for allowing airflow therethrough, the body (22) having a sound inlet aperture (25); a smoke detector (30) mounted to the body for communication within the chamber (20); an electrical circuit operatively connected to the smoke detector (30), the circuit providing an electrical signal when the smoke detector (30) detects smoke in the chamber (20); and a piezoelectric disc (40) mounted external to the chamber adjacent to the sound inlet aperture, the piezo disc (40) operable in response to the electrical signal to generate sound. The smoke detection chamber (20) is sized substantially in accordance to the Helmholtz formula to cause resonance at the operating frequency of the piezo disc (40).

### FIELD OF THE INVENTION

The present invention relates to smoke alarm assemblies, and in particular to unitary, stand-alone smoke alarms incorporating both smoke detection means and alarm means. Such alarms are typically used for domestic applications.

### BACKGROUND

Domestic smoke alarms typically operate using either of two alternative smoke detection means, these being photoelectric means and ionisation means. The two means detect smoke by completely different principles. However, in each case, the detection means requires a smoke chamber which occupies significant space within the smoke alarm.

In the case of a photoelectric smoke alarm, the smoke detection chamber is typically defined by a body having a plurality of openings in the form of a labyrinth for allowing airflow therethrough while at the same time excluding ambient light.

A smoke alarm must be able to both detect smoke and trigger an audible output to the high sound pressure levels dictated in national and international standards. The standards require very high levels of sound pressure in an attempt to disturb people when sleeping. Some alarms have remote signalling for remote audible or visual indication of a smoke alarm in an alarm state.

Many smoke alarms use an acoustic horn made by a piezo disc coupled to a frequency matching resonance cavity, that is either connected to an electrical circuit by flying leads or spring/electrical contacts. Acoustic horns are typically made in all sorts of shapes but usually follow the principles of the Helmholtz formula for the resonant cavity coupling. This cavity is a resonant frequency matching the frequency of the piezo disc so that maximum sound output can be achieved.

The first smoke alarms appearing in the marketplace were very large in size. This was due to the technology of the smoke detection unit and its alarm size. Many improvements have been made to allow smoke to enter the chamber more easily and to reduce the size of the alarm.

Smoke alarms are compulsory in new homes in many countries due to the benefits they offer. Feedback from the market indicates that smoke alarms need to be made smaller and less obtrusive especially for the domestic market.

It is an object of the present invention to provide a smoke alarm of compact size.

It is a further object of the present invention to provide a smoke alarm with fewer parts for ease of manufacture and reduced cost.

### SUMMARY OF THE INVENTION

According to a first aspect of the invention, there is provided a compact smoke alarm assembly comprising:

a smoke detection chamber defined by a body having a plurality of openings for allowing airflow therethrough, the body having a sound inlet aperture;

a smoke detector mounted to the body for communication within the chamber;

an electrical circuit operatively connected to the smoke detector, the circuit providing an electrical signal when the smoke detector detects smoke in the chamber; and

a sound generating device mounted external to the chamber adjacent to the sound inlet aperture, the sound generating device operable in response to the electrical signal;

wherein the smoke detection chamber is sized and shaped to cause resonance at the operating frequency of the sound generating device.

Preferably the sound generating device is a piezoelectric disc.

Preferably the assembly further comprises an annulus surrounding the sound inlet aperture, the annulus supporting the piezoelectric disc.

Preferably the body is dimensioned such that the volume of the chamber is substantially in accordance to the Helmholtz formula at the operating frequency of the sound generating device, thereby providing an efficient acoustic coupling.

According to a second aspect of the invention, there is provided a compact smoke alarm assembly comprising:

a smoke detection chamber defined by a body having a plurality of openings for allowing airflow therethrough, the body having a sound inlet aperture;

a photoelectric sensor mounted to the body for communication within the chamber;

a light source mounted to the body for communication with the chamber;

an electrical circuit operatively connected to the smoke detector, the circuit providing an electrical signal when the smoke detector detects smoke in the chamber; and

a sound generating device mounted external to the chamber adjacent to the sound inlet aperture, the sound generating device operable in response to the electrical signal;

wherein the smoke detection chamber is sized and shaped to cause resonance at the operating frequency of the sound generating device.

Preferably the body comprises:

an upper wall;

a lower wall; and

a peripheral wall, the peripheral wall comprising a plurality of labyrinth members arranged in a partly overlapping circular patent so as to substantially prevent the entry of light into the chamber while allowing sound to exit at high sound pressure levels.

Preferably the sound generating device is a piezoelectric disc.

Preferably the assembly comprises an annulus surrounding the sound inlet aperture, the annulus supporting the piezoelectric disc.

Preferably the body is dimensioned such that the volume of the chamber is substantially in accordance to the Helmholtz formula at the operating frequency of the sound generating device, thereby providing an efficient acoustic coupling.

### DETAILED DESCRIPTION OF PREFERRED EMBODIMENT OF THE INVENTION

A preferred embodiment of the invention is illustrated in the accompanying representations in which:

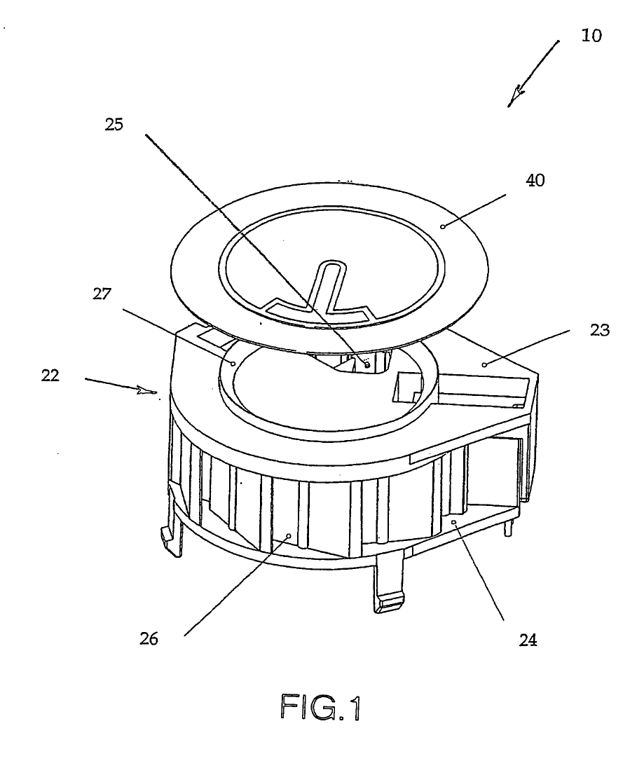

FIG. 1 shows an exploded perspective view of a smoke detector in accordance with a first embodiment of the invention.

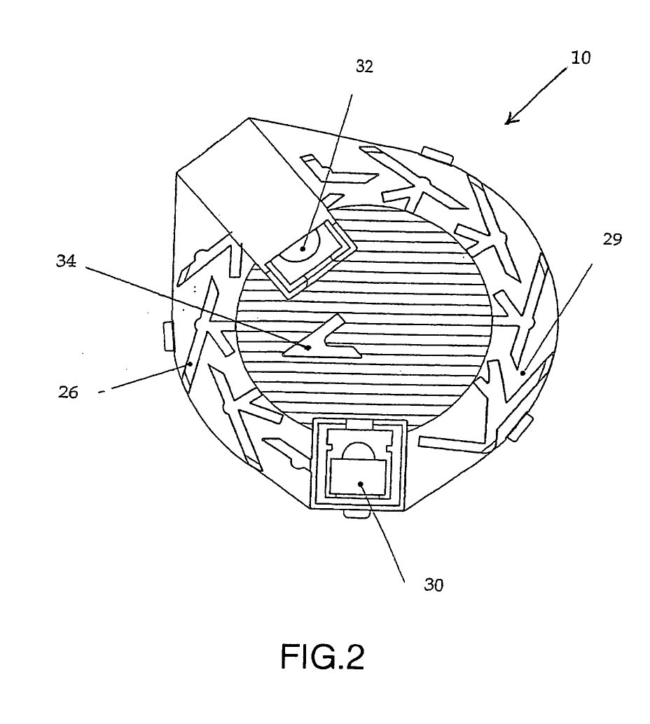

FIG. 2 shows a plan view of the smoke detector of FIG. 1 with its top removed.

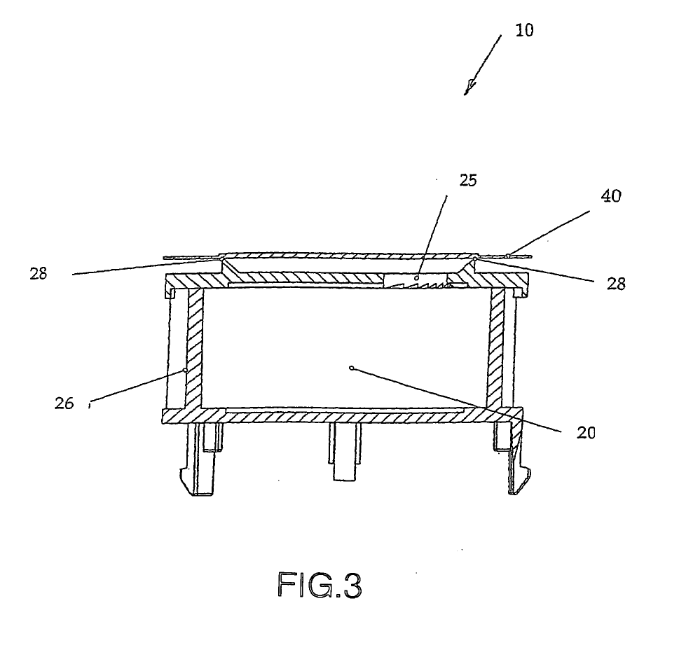

FIG. 3 shows a cross sectional view of the detector of FIG. 1.

Referring to FIGS. 1, 2 and 3, a smoke alarm comprising a body 22, a light emitter 32, smoke detector 30 and a piezo disc 40 is shown. The body 22 defines a smoke detection chamber 20. An electrical circuit (not shown) is operatively connected to the smoke detector 30 to provide an electrical signal to the piezo disc 40 when the smoke detector 30 detects smoke in the chamber 20. (The smoke detector is actually detecting light levels as reflected off the smoke particles, but will be referred to as a smoke detector in this text.)

The piezoelectric disc 40 is mounted external to the chamber adjacent to a sound inlet aperture 25 as is shown in FIGS. 1 and 3. Importantly the smoke detection chamber is sized to cause resonance at the operating frequency of the piezo disc. This enables the chamber to function as an amplifying horn producing a loud sound output.

The smoke alarm 10 is of reduced size since the horn and the smoke detection space are formed by one body 22 to form a single chamber 20 with two functions. By doing this the overall size of the smoke alarm can be considerably reduced and makes possible smoke alarms having a diameter of up to 50% less than the diameter of typical current models being sold on the Australian market.

An important feature of the smoke detector 10 is that the piezo disc is fitted outside of the chamber. This arrangement is simple and has minimal effects on the height of the chamber. Mounting of the piezo disc 40 is straightforward as the connections are outside of the chamber 20. Referring to FIGS. 1 and 3, the piezo disc 40 is supported by a piezo mount 27 terminating in a raised ring 28. The ring 28 is sized to hold the piezo disc at its vibrational node. By keeping the piezo disc 40 outside the chamber 20 any problems of light reflectance by the piezo disc 40 are removed.

As the smoke chamber 20 itself is designed to the Helmholtz formula it becomes a tuned resonance cavity and the sound output is very good. The sound made by the piezo disc 40 travels out of the chamber 20 by the airflow openings 29 used to allow the smoke to enter the chamber. The disc 40 itself emanates additional sound outside of the chamber. The piezo disc 40 can also be directed to vents to maximise the sound transmitted outside of the smoke alarm 10.

Typical piezo discs that give the required sound output at a frequency of about 3 kHz are about 35 mm in diameter. When fitting the disc 40 to the outside of the chamber 20 the chamber itself can be made small with the disc 40 being larger than the chamber 20. Again this allows the smoke alarm 10 to be smaller as the disc 40 can be placed either at the top 23 or base 24 of the chamber 20 in a way that minimises the dimension of the protrusion into the room.

FIGS. 1 to 3 show a particular photo-chamber design. With this particular design, the photo-chamber 20 is defined by a top in the form of an upper wall 23, a base in the form of a lower wall 24 and a plurality of spaced apart labyrinth members 26 arranged in a loop. The labyrinth member 26 is an arrangement of the body 22, designed to avoid ambient light reaching the detector 30 under normal (non smoke) conditions. The shield 34 is placed to prevent direct light entering the detector from the light emitter. This does not restrict the invention to this type of smoke detection device as the invention can be applied to both photoelectric and ionisation smoke type alarms.

With the smoke detector of this particular embodiment of the invention, the photo-chamber 20 has a labyrinth shape similar to a letter K. The “K” shape is orientated to offer a very large entry catchment area to maximise the area for smoke to enter the labyrinth. The restricted area or overlap is kept to a minimum, again allowing smoke to enter freely but the overlap prevents the outside ambient light sources from entering the photo-chamber 20. This has been achieved by having a sharp edge. The sharp edge minimises the land length of the most restricted area.

The volume of the airspace within the chamber 20 has been based on the Helmholtz formula for resonant cavities. Many different shaped openings and labyrinths can be used to achieve the desired result. It is not essential to use a K shaped labyrinth.

The piezo disc 40 can be held to the chamber 20 by electrical contact springs or glued to the chamber 20 with any other fixing means, with flying leads providing the electrical contacts.

The dimension of the chamber 20 is determined by the frequency of the piezo disc 40 and the tuned volume within the chamber 20. With the embodiment of the invention illustrated in FIGS. 1 to 3, the alarm frequency is at about 3 kHz. Other alarm frequencies may be used.

A chamber 20 has been produced with normal manufacturing processes and has been tested for sound pressure as stipulated in AS3786 1993 (85 dbA, at 3 meters) and has met these requirements.

The body 22 defining the chamber 20 can be constructed from plastic, metal or any other suitable materials.

While the present invention has been described in terms of a preferred embodiment in order to facilitate better understanding of the invention, it should be appreciated that various modifications can be made without departing from the principles of the invention. Therefore, the invention should be understood to include all such modifications within its scope. The same principles of operation can equally be applied to ionisation type chambers.

1. A compact smoke alarm assembly comprising:
a smoke detection chamber defined by a body having a plurality of openings for allowing airflow therethrough, the body having a sound inlet aperture;
a smoke detector mounted to the body for communication within the chamber;
an electrical circuit operatively connected to the smoke detector, the circuit providing an electrical signal when the smoke detector detects smoke in the chamber; and
a sound generating device mounted external to the chamber adjacent to the sound inlet aperture, the sound generating device operable in response to the electrical signal;
wherein the smoke detection chamber is sized and shaped to cause resonance at the operating frequency of the sound generating device.

2. An assembly as claimed in claim 1 wherein the sound generating device is a piezoelectric disc.

3. An assembly as claimed in claim 2 further comprising an annulus surrounding the sound inlet aperture, the annulus supporting the piezoelectric disc.

4. An assembly as claimed in claim 1 wherein the body is dimensioned such that the volume of the chamber is substantially in accordance to the Helmholtz formula at the operating frequency of the sound generating device, thereby providing an efficient acoustic coupling.

5. A compact smoke alarm assembly comprising:
a smoke detection chamber defined by a body having a plurality of openings for allowing airflow therethrough, the body having a sound inlet aperture;
a photoelectric sensor mounted to the body for communication within the chamber;
a light source mounted to the body for communication with the chamber;
an electrical circuit operatively connected to the smoke detector, the circuit providing an electrical signal when the smoke detector detects smoke in the chamber; and
a sound generating device mounted external to the chamber adjacent to the sound inlet aperture, the sound generating device operable in response to the electrical signal;
wherein the smoke detection chamber is sized and shaped to cause resonance at the operating frequency of the sound generating device.

6. An assembly as claimed in claim 5 wherein the body comprises:
an upper wall;
a lower wall; and
a peripheral wall, the peripheral wall comprising a plurality of labyrinth members arranged in a partly overlapping circular patent so as to substantially prevent the entry of light into the chamber while allowing sound to exit at high sound pressure levels.

7. An assembly as claimed in claim 6 wherein the sound generating device is a piezoelectric disc.

8. An assembly as claimed in claim 7 further comprising an annulus surrounding the sound inlet aperture, the annulus supporting the piezoelectric disc.

9. An assembly as claimed in claim 6 wherein the body is dimensioned such that the volume of the chamber is substantially in accordance to the Helmholtz formula at the operating frequency of the sound generating device, thereby providing an efficient acoustic coupling.

10. (canceled)

11. A compact smoke alarm assembly comprising:
a smoke detection chamber defined by a body having a plurality of openings for allowing airflow therethrough, the body having a sound inlet aperture;
a smoke detector mounted to the body for communication within the chamber;
an electrical circuit operatively connected to the smoke detector, the circuit providing an electrical signal when the smoke detector detects smoke in the chamber; and
a sound generating device mounted external to the chamber adjacent to the sound inlet aperture, the sound generating device operable in response to the electrical signal; wherein:
the smoke detection chamber is configured to cause resonance at an operating frequency of the sound generating device; and
the body is configured such that the volume of the chamber is generally in accordance to the Helmholtz formula at the operating frequency of the sound generating device.

12. An assembly as claimed in claim 11, wherein the sound generating device is a piezoelectric disc.
